(19) United States
(12) Patent Application Publication
(10) Pub. No.: US 2005/0249907 A1
(43) Pub. Date: Nov. 10, 2005

(54) Sealing profile

(75) Inventors: Heiko Ranzau, Bockenem (DE); Helmut Krebs, Michelstadt (DE)

Correspondence Address: SYNNESTVEDT & LECHNER, LLP, 2600 ARAMARK TOWER, 1101 MARKET STREET, PHILADELPHIA, PA, 191072950, US

(73) Assignee: Meteor Gummiwerke K.H.Bädje GmbH & Co. KG, Bockenem (DE)

(21) Appl. No.: 10/526,119

(22) PCT Filed: Jun. 27, 2003
(86) PCT No.: PCT/EP03/06809

§ 371 Date: Feb. 28, 2005

(30) Foreign Application Priority Data
Sep. 3, 2002 (DE) 202 13 494.6

(51) Int. Cl. B32B 1/08

(52) U.S. Cl. 428/36.91

(57) ABSTRACT

A sealing profile intended to seal a gap between the outer boundary of a motor vehicle door and its allocated opening of a motor vehicle construction comprises a tube-like construction that consists of at least two tubular profiles (4, 5) that are disposed one inside the other. The two tubular profiles are produced for example during co-extrusion and are formed in terms of construction and material with the proviso that the inner tubular profile (5) provides a resilient restoring force whereas the outer tubular profile (4) is chosen with regard to its surface properties, in particular the provision of a sealing function, which requires adaptation to dimensional inaccuracies and inequalities in the region of the boundary surfaces defining the sealing gap. An adhesive region (2) that is intended to connect to the one of the two boundaries is applied to the sealing profile. For example, the inner tubular profile can consist of silicone and the outer tubular profile can consist of sponge rubber or soft rubber. A product that fulfills all of the mechanical and thermal boundary conditions of the automotive industry and that can be used to the greatest possible flexible extent is provided.

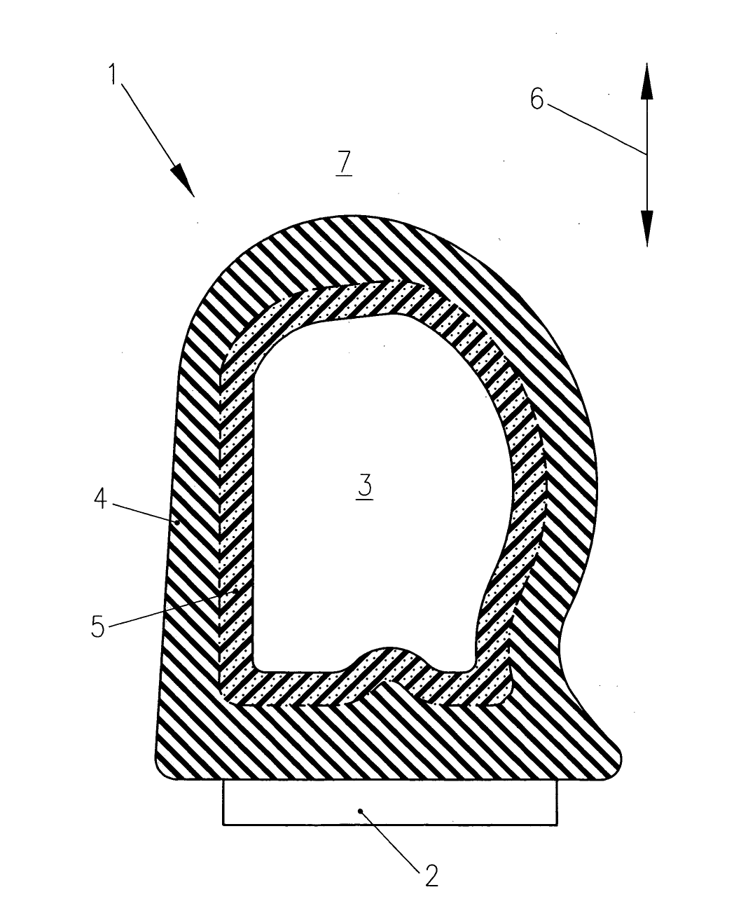

The invention relates to a sealing profile in accordance with the preamble of claim 1.

Sealing profiles are known in a variety of forms and are in the form of either a solid or tubular profile, wherein the cross-sectional form and/or the material are chosen with the proviso that good adaptability to irregularities as well as to dimensional inaccuracies of the gap to be sealed and sufficient restoration capabilities are ensured.

The sealing profile remains under elastic stress until it has fulfilled its sealing function, when it is pressed against the boundaries that are opposite one another and define the gap to be sealed. This pressing force in the region of the boundaries or sealing surfaces is to be uniform over time under the respective operating conditions so that the sealing profile will deform back to its original shape during the transfer into an inactive unstressed state by converting the previously stored elastic energy.

Further essential properties for a sealing profile relate to surface properties, in particular suitability for connection to other materials which is important for example in motor vehicle sealing profiles. Finally, the sealing profile has to be efficiently producible on the basis of the chosen material and must retain its properties, that are essential for fulfilling the sealing function, almost unaltered in a temperature range of at least −40° C. to approximately +110° C.

The above requirements are only partly achieved by the currently known sealing profiles, in particular for tubular profiles.

A comparable tube-like sealing profile that is intended to be used in motor vehicle doors is known from EP 0 836 962 A1 and consists of an inner profile that surrounds a hollow space, consists of an open-cell foamed thermoplastic material having a low density and is surrounded on the exterior by a of a [sic] closed-cell foamed thermoplastic profile having a higher density. A lateral portion of the outer profile is used for attachment to structural parts e.g. of a motor vehicle door. Whilst the outer profile is used to provide sealing properties as well as a pleasing visual appearance, the purpose of the inner profile is to provide resilient properties as well as a sufficient creep resistance. The outer profile having the character of a coating has a thickness between 0.5 mm and 1.0 mm, wherein this thickness is chosen in order to permit the sealing profile to be installed in accordance with small radii without any creases. The production of this known tubular profile can be effected in two stages for example, wherein firstly the inner profile that has a relatively thicker wall thickness is produced during extrusion and wherein the second profile is then applied onto the first, once again using an extruder.

A further tube-like sealing element that consists of two profiles surrounding each other and is intended for use in motor vehicles is known from EP 0 822 052 A1, wherein the inner and outer profiles of the sealing element can equally consist of sponge rubber. The production of such a sealing profile assembled from two profile parts can be effected during co-extrusion. Whilst the outer profile is intended to provide the sealing functions, the inner profile is used to improve carrying capacity.

On the basis thereof, it is the object of the invention to create a sealing profile of the type mentioned in the introduction with regard to simple efficient production, sufficient restoration capability, an excellent sealing capacity and such surface properties in the region of the outer surfaces which permit simple possibilities for applying a coating, such as an anti-friction lacquer, fiber coating or the like. This object is achieved for a sealing profile of the generic type by means of the features of the characterizing part of claim 1.

The tubular profile consists of two profiles that are disposed one inside the other and can be connected to each other. The basic principle of the subject matter of the invention resides in the fact that the two tubular profiles are to be chosen with the proviso that they each fulfill, in addition to a mere connecting capability, essential properties of the sealing profile such as, for example, sufficient restoration capability on the one hand and surface properties in the region of the outer surfaces on the other hand. Consequently, optimization of the two profiles in terms of construction and material is additionally provided, based on the possibilities for efficiently assembling the sealing profile and good adaptability to mechanical and thermal property requirements.

The sealing profile in accordance with the invention is to be seen as a product which can be further processed to the greatest possible extent since its outer surface properties permit different possibilities for coating and adhering with other materials.

In accordance with the invention, a tubular profile combination is proposed, wherein it is hereby assumed that the resilient restoring force of the sealing profile is essentially applied by the inner tubular profile, whereas the outer tubular profile essentially has a sealing function since this, owing to its soft nature, permits precise adaptation to dimensional inaccuracies and inequalities in the region of the boundary surfaces defining the sealing gap. The pressing force necessary for maintaining the seal is applied by the elastic deformation of the inner tubular profile occurring during the sealing phase. By virtue of the fact that the inner tubular profile is produced from silicone and the outer tubular profile is produced from a sponge rubber, soft rubber or of another elastomer such as for example an EDPM or TPE, the above requirements can be fulfilled in every regard.

In accordance with the features of claim 2, this material combination also permits efficient production possibilities during co-extrusion that is known per se.

The features of claims 3 and 4 relate to alternative possibilities of coating the outer surface of the outer tubular profile. In this regard, the coating can be fiber coating, application of a lacquer e.g. an anti-friction lacquer or also a film that has been applied in a hot melt coating method.

In accordance with the features of claims 5 and 6, the sealing profile in accordance with the invention can selectively be in an annular structure or as a wound product. In particular, in the case of the used material combination of the two tubular profiles, there is also the possibility of a subsequent, end-side adhesion process, in order to produce an annular structure.

It can be seen from the above embodiments that in the sealing profile in accordance with the invention a product is produced that fulfills all of the mechanical and thermal boundary conditions, can be used to the greatest possible flexible extent and can be used in particular in the automotive industry.

The FIGURE in the drawing shows the cross-section of a sealing profile 1 that serves to seal a gap between parts that can move relative to each other, for example between the outer boundary of a motor vehicle door and the inner boundary, facing said outer boundary, of the opening to be closed by the door. The sealing profile 1 is characterized on one side by a strip-like adhesive region 2 via which it can be connected to the outer boundary of the motor vehicle door or the inner boundary of said opening. However, this adhesive technology as such is not the subject matter of the invention and will not be described in detail hereinafter.

The sealing profile 1 is formed in a tube-like manner and surrounds a through-going, identically-formed hollow space 3. It is incidentally constructed from an outer tubular profile 4 and an inner tubular profile 5, which tubular profiles are formed in different ways in terms of material and with regard to their functions in terms of the sealing profile.

The inner tubular profile 5 consists of silicone in accordance with the invention. It is dimensioned and arranged with the proviso that the sealing profile 1, that undergoes deformations in the direction of the arrow 6 in dependence upon the relative position of the boundaries defining the gap to the sealed, is given a sufficient, resilient restoration capability that is stabile over time. Consequently, it fulfills a substantial function when the necessary pressing force in the region of the sealing surfaces is provided. This restoration capability is mainly provided by the inner tubular profile 5 and only an unsubstantial amount by the outer tubular profile 4.

In contrast thereto, the outer tubular profile 4 consists of a soft rubber, e.g. EPDM, and owing to its mechanical properties is used for precise adaptation to the boundaries of the gap to be sealed. It thus consists of a relatively softly conditioned material in comparison with the inner tubular profile 5. Furthermore, it is chosen in accordance with the invention with regard to its surface properties and can be completely or partly covered with an anti-friction lacquer or other surface coatings e.g. a fiber coating. A substantial further property of the outer tubular profile 4 thus resides in its suitability for adhesion with conventional coatings that are used in the outer region of such sealing profiles, in particular the ability to use a stabile, heat-resistant and wear-resisting bond.

The boundaries of the gap to be sealed are not illustrated in the drawings. A connection to the one boundary is always provided via the adhesive region 2 so that the other boundary is disposed opposite the region 2 and is located for example at location 7. The boundaries can be moved in the direction of the arrow 6 to effect a sealing effect or to discontinue the sealing effect.

The two tubular profiles 4, 5 can advantageously be produced as continuous profiles during co-extrusion, wherein a connection between the two profiles is possible by means of a cross-linking arrangement or also by means of adhesive. The sealing profile 1 can thus be produced continuously in an in-line process and is characterized, in addition to a high, resilient adjustment capability, by heat-resistant and surface properties that are specifically suited to the requirements of sealing profiles used in the automotive industry.

1. Sealing profile (1) for sealing a gap between the outer boundary of a flat, movable first part and the inner boundary of an opening in a fixedly disposed second part that can be closed by the first part, for example for sealing the gap between a motor vehicle door and its allocated opening of a motor vehicle construction, having a strip-like adhesive region (2) that is intended to connect to one of the boundaries, having a tube-like construction surrounding a hollow space (3) and consisting of at least two tubular profiles that are disposed one inside the other and can be connected to each other,
characterized in that
the two tubular profiles are created in different ways in terms of material, wherein the inner tubular profile (5) is chosen according to its resilient restoring force and wherein the outer tubular profile (4) is chosen according to its surface properties; in particular its ability to be coated and in comparison to the inner tubular profile (5) has a softer nature and a lower restoring force and wherein the inner tubular profile (5) consists of silicone and the outer tubular profile consists of a sponge rubber or a

2. Sealing profile (1) according to claim 1, characterized in that the two tubular profiles are profiles that can be connected to the sealing profile during co-extrusion in an in-line process.

3. Sealing profile according to claim 1, characterized by a coating such as an anti-friction lacquer or fiber coating etc. that is applied to the exterior of the outer tubular profile (4) and at least partly covers this outer surface.

4. Sealing profile (1) according to claim 1, characterized by a film that is connected to the exterior of the outer tubular profile (4), is applied in a hot melt coating method and forms an outer coating.

5. Sealing profile (1) according to claim 1, characterized by a construction as a wound profile.

6. Sealing profile according to claim 1, characterized by a closed, annular construction.

7. Sealing profile according to claim 2, characterized by a coating such as an anti-friction lacquer or fiber coating etc. that is applied to the exterior of the outer tubular profile (4) and at least partly covers this outer surface.

8. Sealing profile (1) according to claim 2, characterized by a film that is connected to the exterior of the outer tubular profile (4), is applied in a hot

9. Sealing profile (1) according to claim 3, characterized by a film that is connected to the exterior of the outer tubular profile (4), is applied in a hot melt coating method and forms an outer coating.

10. Sealing profile (1) according to claim 2, characterized by a construction as a wound profile.

11. Sealing profile (1) according to claim 3, characterized by a construction as a wound profile.

12. Sealing profile (1) according to claim 4, characterized by a construction as a wound profile.

13. Sealing profile according to claim 2, characterized by a closed, annular construction.

14. Sealing profile according to claim 3, characterized by a closed, annular construction.

15. Sealing profile according to claim 4, characterized by a closed, annular construction.
